(19) United States
(12) Patent Application Publication
(10) Pub. No.: US 2009/0216656 A1
(43) Pub. Date: Aug. 27, 2009

(54) Method and System for Managing Vendor Information

(76) Inventor: Donald J. Cerimeli, Chandler, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 12/390,997

(22) Filed: Feb. 23, 2009

Related U.S. Application Data
(60) Provisional application No. 61/030,543, filed on Feb. 21, 2008.

(51) Int. Cl. G06Q 10/00; G06Q 30/00

(52) U.S. Cl. 705/26; 705/34

(57) ABSTRACT

A website for managing vendor information stores information associated with one or more purchase orders of a purchaser, including information associating the purchase order with a vendor authorized to access the website. The website is used to allow the vendor to retrieve the purchase order, automatically notify the purchaser of the vendor's receipt of the purchase order, allow the vendor to create an invoice associated with the purchase order, and automatically enter the invoice into an accounts payable system of the purchaser. With the website, the vendor can manage purchase orders and create and submit invoices. The purchaser can use the website to monitor the vendor's performance.

### RELATED APPLICATION

This application claims the benefit of U.S. Provisional Application No. 61/030,543, filed Feb. 21, 2008, entitled “Method and System for Managing Vendor Information,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates to methods and systems for managing vendor information. More particularly, it relates to a method and system for managing vendor information that allows vendors to pick up purchase orders from a purchaser and to electronically invoice the purchaser and that allows the purchaser to manage and evaluate vendors and purchase transactions.

Tracking information relating to purchases is a very important tool for companies who deal with many vendors. For example, in the vehicle rental business, it is important for the purchaser of a part to know when the vendor will ship the part and when the part has been delivered (for proof of delivery [POD]). There are many steps involved in placing an order and various people required to enter or transfer information, which translates into longer order processing times and the increased risk of data entry errors being made when manually entering information. Additionally, tracking orders through to delivery is very difficult.

Previously, all order information had to be sent by mail, e-mail or fax and responses had to be sent the same way. This required that information be handwritten on a purchase order (PO), sent to the vendor, and then manually entered into the vendor's order system.

Some purchasers and vendors have electronically exchanged certain data using Electronic Data Interchange (EDI), which facilitates the transfer of machine-readable information between computer systems. EDI standards were developed to streamline communications between business organizations. Although EDI is widely used by organizations for the large-volume exchange of information, it often requires the purchase of special software that provides the functionality needed to translate data to an EDI format for further processing at another computer system. The actual formats required at various computer systems may vary, so data formatting or mappings/translations specific to each of the computer systems with which an organization communicates may be required to complete all of its EDI transactions. The expense and inconvenience of implementing EDI effectively prohibits smaller volume vendors from doing so. Moreover, vendors who can implement EDI often do not receive all of the functionality that they need for managing their data.

It is an object of the present invention, therefore, to provide a method and system for managing vendor information that allows non-EDI vendors to electronically submit invoice information to the purchaser.

It is still another object of the invention to provide a system and method for managing vendor information that minimizes the need for the purchasing company's personnel to manually enter information that allows the purchaser to track purchase order information.

It is yet another object of the invention to provide a system and method for managing vendor information that improves speed and accuracy in order placement and improved communication for following up on order status.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a method and system for managing vendor information using a website. The website stores information associated with one or more purchase orders of a purchaser, including information associating the purchase order with a vendor authorized to access the website. The website is used to: allow the vendor to retrieve the purchase order; automatically notify the purchaser of the vendor's receipt of the purchase order; allow the vendor to create an invoice associated with the purchase order; and automatically enter the invoice into an accounts payable system of the purchaser.

According to one advantageous embodiment and method of the invention, the website can be used to allow the vendor to assign the purchase order a status and to automatically notify the purchaser of the vendor's assignment of a status to the purchase order. The vendor can input shipment tracking information associated with a purchase order and can view the status history of a purchase order. The vendor also can input and view and invoices and status information associated with the invoice, including whether the invoice has been submitted, accepted or paid. The vendor also can use the website to create a credit memo associated with the invoice.

The website also can store information associated with the vendor and the vendor's performance, which the purchaser can view and monitor. This information can include, for example: information relating to purchase orders that have not been acknowledged by the vendor; information relating to purchase orders that have not been assigned a status within a specified time; information relating to purchase orders that include backordered items; and information relating to timeliness of the vendor's shipments. Other stored information can include agreements associated with the vendor.

Using the method and system of the invention, the purchaser can track information so the purchaser knows when to expect the purchased item. The invention eliminates many of the problems inherent in the necessity of multiple people manually entering information. It provides for speed and accuracy in order placement and improved communication for following up on order status. Vendors can also submit invoices directly through the program, which communicates directly with the vendor's accounts payable (AP) department, allowing vendors to bill more accurately for what has been shipped and to be paid in a timely manner.

The invention also provides access to all communications between the purchasing company's buyers and the vendor, and all contracts, contacts, and tariffs so there is no need for manual files—if an order has been shipped and additional information is needed on the order, it is available.

With the invention, there is no longer a need to mail, e-mail or fax orders, which will increase the accuracy of older placement and fulfillment and reduce the opportunity for errors to be entered into the order process. Vendors log on and enter information directly and only one time.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 is a functional block diagram of a preferred computer system and a network for practicing the present invention.

FIG. 2 shows an exemplary screen display of a vendor main page according to the invention.

FIG. 3 shows an exemplary screen display of an account management page according to the invention.

FIG. 4 shows an exemplary screen display of a page for adding a new user account for a vendor.

FIG. 5 shows an exemplary screen display of editing a user account.

FIGS. 6A-H show exemplary screen displays illustrating searches for purchase orders.

FIG. 7 shows an exemplary screen display of a page for printing a purchase order.

FIG. 8 shows an exemplary screen display for printing batches of purchase orders.

FIGS. 9A-9B show exemplary screen displays of purchase order lists with the results of purchase order searches.

FIGS. 10A-B show exemplary screen displays for processing purchase orders.

FIGS. 11A-B show exemplary screen displays for displaying a purchase order number and the outstanding items that are left to status.

FIGS. 12A-C show exemplary screen displays for assigning a carrier and associated tracking number to each ship date associated with a purchase order.

FIG. 13 shows an exemplary screen display for viewing the status history of a purchase order.

FIGS. 14A-B show exemplary screen displays for assigning information for each line item on the purchase order by a release date.

FIGS. 15A-B show exemplary screen displays for canceling a remaining quantity on a purchase order or advising the purchaser that the remaining quantity will be shipping at a later date.

FIGS. 16A-E show exemplary screen displays for assigning tracking information to a purchase order.

FIG. 17 shows an exemplary screen display of tracking information associated with a purchase order.

FIG. 18 shows another exemplary screen display for viewing the status history of a purchase order

FIGS. 19A-B show exemplary screen displays for creating an invoice.

FIG. 20 shows exemplary screen displays for verifying an invoice.

FIG. 21 shows an exemplary screen display that shows invoices numbers associated with a purchase order.

FIG. 22 shows an exemplary screen display for viewing invoices that have been created.

FIGS. 23A-B show exemplary screen displays for creating a credit memo associated with a purchase order.

FIG. 24 shows an exemplary screen display for verifying an invoice to be credited according to a credit memo.

### DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

The present invention relates to a method and system for managing vendor information. According to one aspect of the invention, a web-based system allows vendors to log on to a website and retrieve purchase order information while providing the purchaser the ability to more closely and accurately track purchase orders. A purchase order is sent to the vendor using the vendor management system, at which time the vendor can accept the purchase order and assign it a status (e.g., in process, back-ordered, delivered, etc.). The system automatically notifies the purchaser that the purchase order has been received and given a status. The vendor can log in to the vendor management system to create an invoice, which eliminates the necessity of having to send a paper invoice. Invoices entered into the vendor management system are automatically entered into the purchaser's accounts payable (AP) system. The method and system provides a streamlined communication channel between the vendor and purchaser to accurately and efficiently track the status of the purchase order and all communications between the purchaser and the vendor, as well as contracts, contacts, tariffs, etc.

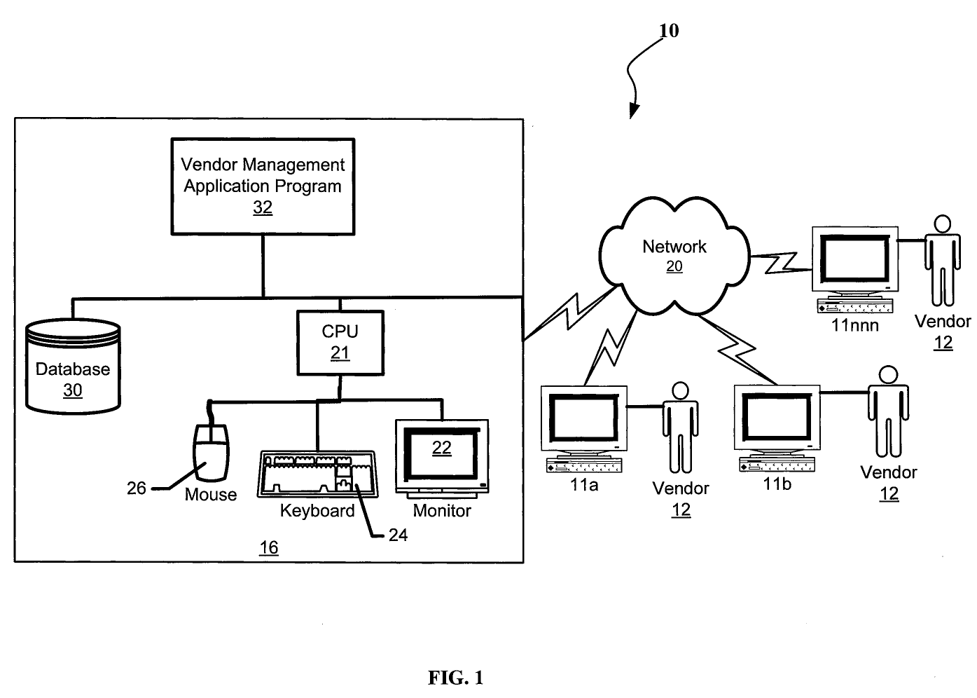

FIG. 1 illustrates a preferred computer network system 10 for practicing the present invention. The network computer system 10 includes a vendor management computer system 16. The computer system 16 stores and processes the vendor management information described below, including information regarding purchase orders and invoices. Users 12a, 12b and 12nnn can access the vendor management computer system 16 via vendor computers 11a, 11b and 11nnn, (where nnn refers to any number of vendors and vendor computers) coupled to the computer system 16 via a computer network 20, such as the Internet, or by other suitable communications means. In a preferred embodiment of the invention, the network 20 comprises the Internet. Upon reading this specification, those skilled in the art will now understand that, under appropriate circumstances, considering issues such as developments in computer hardware, software and connectivity, etc., other network configurations and devices also may suffice, such as for example, PDAs connected via a wireless network, etc.

Still referring to FIG. 1, the vendor management computer system 16 includes a central processing unit (CPU) 21 for processing data and program instructions. The computer system 16 also includes input and output devices, as is well known in the art. For example, the computer system 16 preferably includes a display screen or monitor 22, a keyboard 24, a mouse 26, a printer (not shown), etc. The computer system 16 further includes data storage and memory devices, as are known in the art, for storing a database 30. The database 30 is used to store vendor data, purchase order data and invoice data, as described below. Preferably, the database 30 is a relational database, as is well known in the art. A vendor management application program 32 is operable with the database to provide the functionality described below. In a presently preferred embodiment, the vendor management application program 32 is implemented using the .NET operating system platform marketed by Microsoft Corporation of Redmond, Wash., and the database 30 is implemented using the Oracle database management system marketed by Oracle Corporation of Redwood, Calif. Upon reading this specification, those skilled in the art will now understand that, under appropriate circumstances, considering issues such as developments in computer hardware, software and connectivity, etc., other operating systems, programming languages and database management systems can be used.

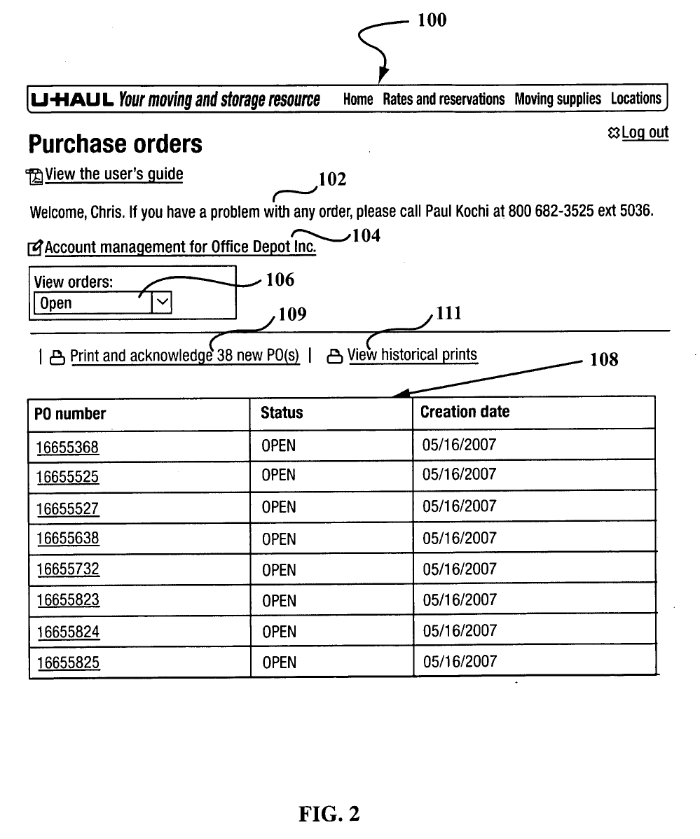

FIGS. 2-24 illustrate the operation of the computer network system 10. Once a vendor has been set up in the vendor management computer system 16, the purchaser can provide to the vendor an administrator's username and password. The user 12 can then can then login to the system on behalf of a vendor using these credentials.

FIG. 2 shows an exemplary display of a vendor main page 100 that is served by the vendor management system 16 to the vendor computer 11 after the user 12 has logged into the system 16. The vendor main page 100 includes a welcome message 102, which displays the contact information for the buyer that the purchaser has assigned to the vendor.

Account Management

The vendor main page 100 also includes an account management link 104, which allows the user 12 to manage the account for the vendor as long as the user 12 has vendor administrator privileges. If the user 12 is logged in and does not have vendor administrator privileges, the account management link 104 will not be visible.

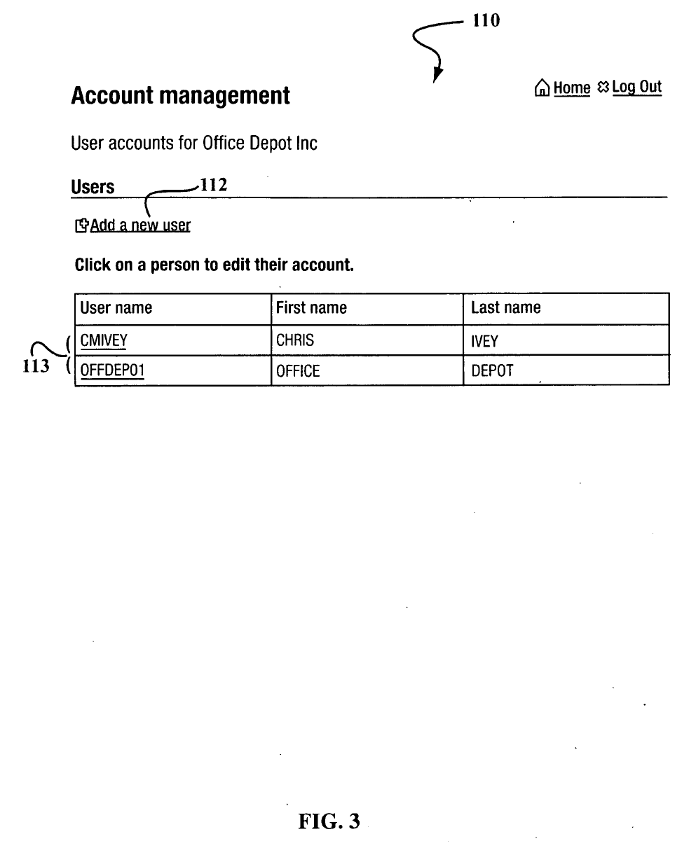

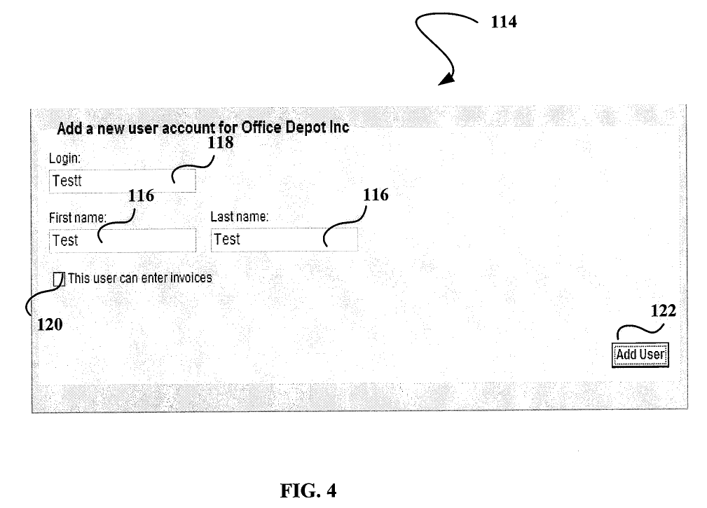

From the vendor main page 100, the user with administrator privileges can add users in the vendor management system 16, by clicking on the account management link 104. In response, the vendor management system 16 then serves an account management page 110 for display on the vendor computer 11, as shown in FIG. 3. To add a new user, the administrator clicks the “Add a new user” link 112 on the account management page 110, and the vendor management system 16 displays an Add New User page 114, as shown in FIG. 4.

The Add New User page 114 includes input fields for entering the new user's name 116 and initial login password 118, which becomes the default password for the new user. Preferably, upon the user's initial login, he or she will be forced to change this default password. Roles allow a user to have certain privileges above and beyond those of a normal user. The Add New User page 114 also includes a role checkbox 120, which can be used to assign a new user a role. In the exemplary Add New User page 114 of FIG. 4, the only additional role is the Invoicing Role, which allows user's to submit new invoices and credit memo's for a vendor. It will be understood, however, that an option of selecting other roles could be provided if necessary or desirable. After the inputs to the Add New User page 114 are completed, the administrator clicks an Add User button 122 to store the new user information in the vendor management system 16.

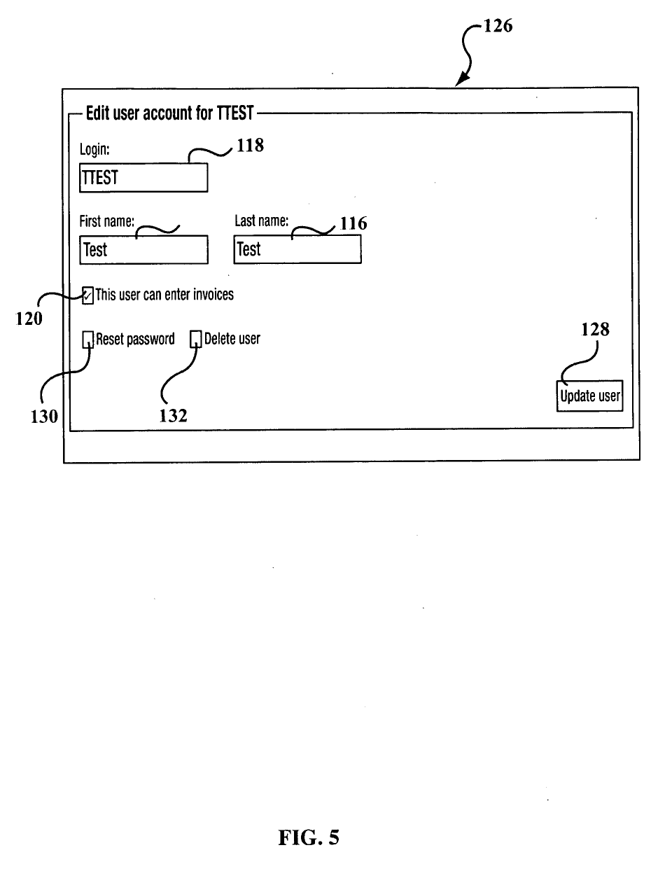

To add a role to or remove a role from a user, the administrator logs in to the system and navigates to the account management page 110. Clicking on the user for whom the role is to be added or removed causes the vendor management system 16 to display the Edit User page 126 shown in FIG. 5. By checking/unchecking the role checkbox 120 a role for the user can be added/removed. Clicking the Update User button 128 causes the added/removed role information to be stored in the vendor management system 16. If the addition/removal is successful, the vendor management system 16 returns to the account management screen 150.

To reset a user password, the administrator navigates to the account management page 110 and clicks on the user name list 113 the user to be edited. The vendor management system then displays the Edit User page 126. The administrator can then check the Reset Password checkbox 130 and click the Update User button 128 to store the new information. If the administrator resets a user's password, the system will reset the password to the login of that user. If the administrator resets the administration password, the system will display a screen for changing the password.

If a user (except an administrator) needs to be deleted from the system for any reason, the administrator navigates to the Account Management screen 110 (see FIG. 2) and clicks on the user to be deleted. The Edit User screen 126 (see FIG. 5) is then displayed. The administrator can then check the delete user checkbox 132 and click the Update User button 128 to cause the system will delete that user.

Purchase Order Management.

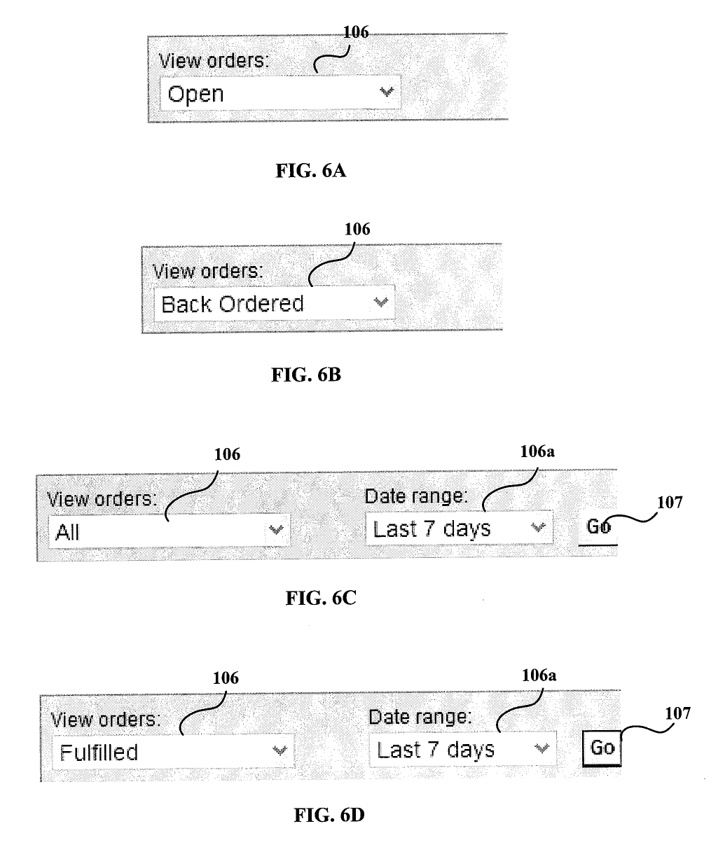

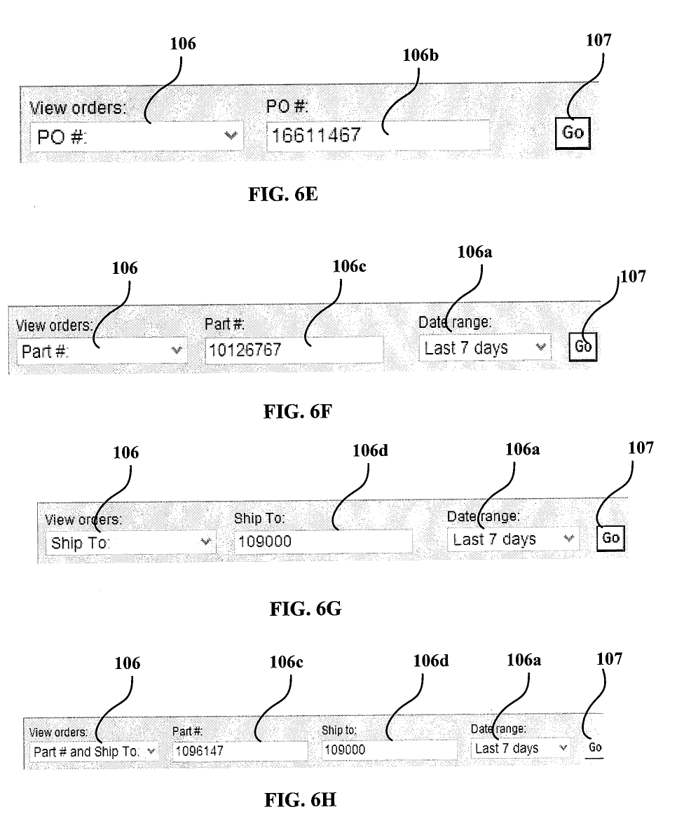

Referring again to FIG. 2, a user can search the database for purchase orders using the View Orders drop down menu 106. The user can search for a specific purchase order, all purchase orders that are open or back ordered, or by entering some basic information, a user can get all purchase orders that have a specific Part Number or have been shipped to a location. FIG. 6A shows a query for Open purchase orders (having at least one line with no status). FIG. 6B shows a query for Back Ordered purchase orders. FIG. 6C shows a query for All purchase orders within a specific date range 106a regardless of status. FIG. 6D shows a query for Fulfilled (fully shipped or shipped/canceled) purchase orders within a specific date range 106a. FIG. 6E shows a search for a specific purchase order number 106b. FIG. 6F shows a query for a specific part number 106c within a specific date range 106a. FIG. 6G shows a query for a specific Ship To designation 106d within a specific date range 106a. FIG. 6H shows a query for a specific Part Number 106c and Ship To designation 106d within a specific date range 106a. After each of the queries of FIGS. 6C-6H is selected from the drop down menu 106, the additional relevant input fields 106a-106d are displayed, and the search is initiated by clicking the Go button 107.

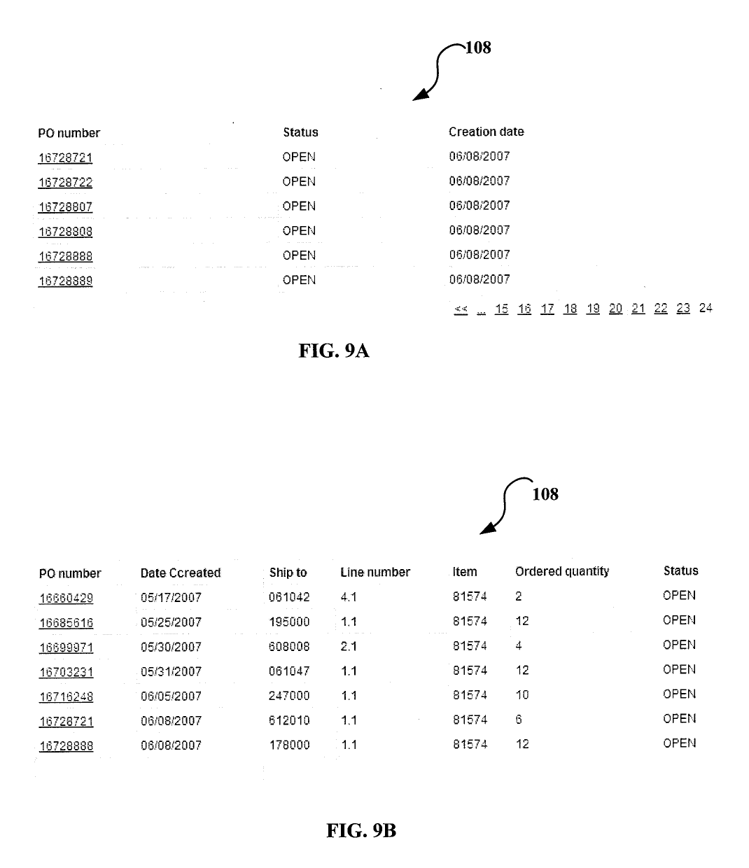

Referring again to FIG. 2, the vendor main page 100 also displays a purchase order list 108, which displays the results of the purchase order searches, such as those shown in FIGS. 6A-6H. For example, in FIG. 2 the purchase order list 108 shows how many new purchase orders remain open. If the user selects the Back Ordered query (see FIG. 6B), the purchase order list will show all of the back orders. If the user selects the All query (see FIG. 6C), the purchase order list 108 will show all purchase orders created in the last seven days, regardless of status and will display the input field 106a as a drop down list to allow the user to change the number of days shown in the purchase order list 108. The purchase order list 108 will show the Purchase Order Number, the Status of the Purchase Order and the Creation Date of the Purchase Order. The list is sorted by Creation Date. FIGS. 9A and 9B show two different views for the purchase order list 108. FIG. 9A shows the last page of a list of open purchase orders. FIG. 9B shows the line status of the part number selected in a search (see FIG. 6F). To assign or view a purchase order shown in the purchase order list 108, the user can click on the associated PO number link.

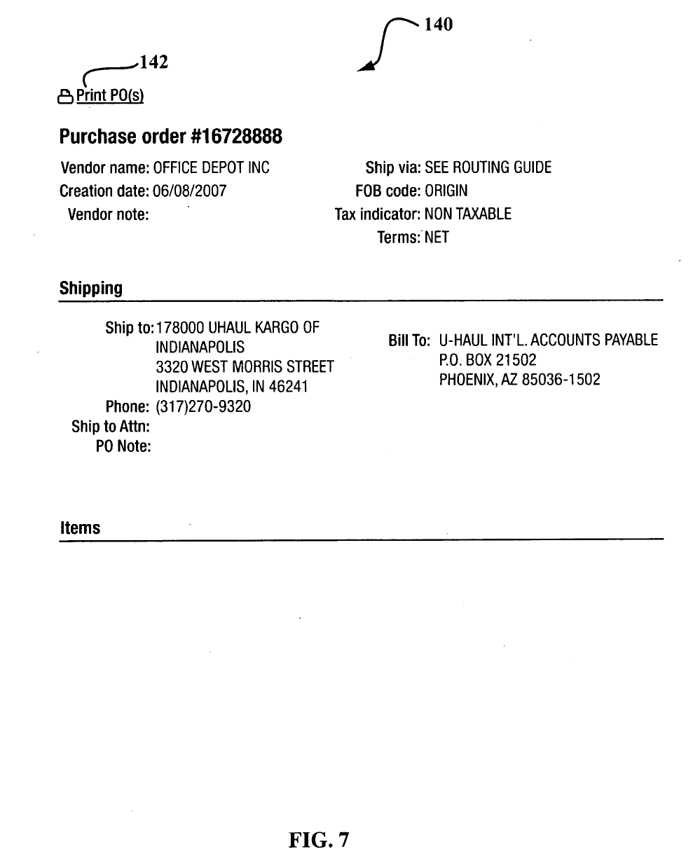

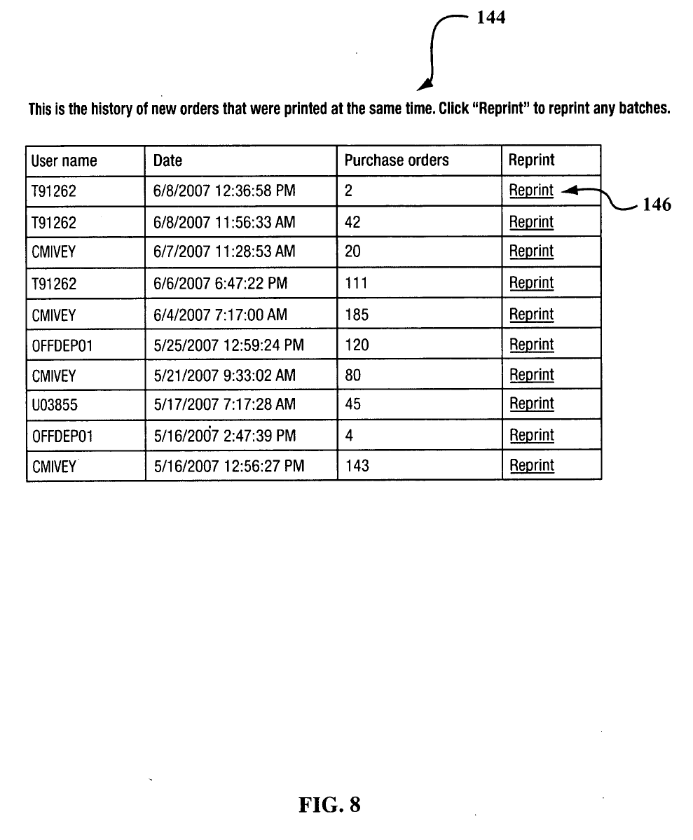

Referring again to FIG. 2, the Print and Acknowledge link 109 allows the user to print the purchase orders displayed in the purchase order list 108 or to reprint up to the last 10 print batches. This will also save the number of purchase orders printed as a “Batch” for printing later if needed. Upon clicking the Print and Acknowledge link 109, the listed purchase orders will be loaded into a Print page 140, as shown in FIG. 7, so that the user can print them. Once the Print page 140 loads, a print dialogue box (not shown) will display. The purchase orders can be printed using the print dialogue box, or they can be printed later by clicking on the Print PO(s) button 142 on the Print page 140. Clicking the Print and Acknowledge link 109 also will send an acknowledgement to the purchaser stating that the vendor has received the purchase order(s).

Batches of purchase orders can be reprinted by clicking on the View Historical Prints link 111 on the main page 100. In response, the system will display a Historical Prints page 144, such as that shown in FIG. 8. The user can click on the Reprint link 146 to reprint the corresponding batch of purchase orders, and the system will redirect back to the Print page 140, as shown in FIG. 7.

Normal Purchase Order Processing

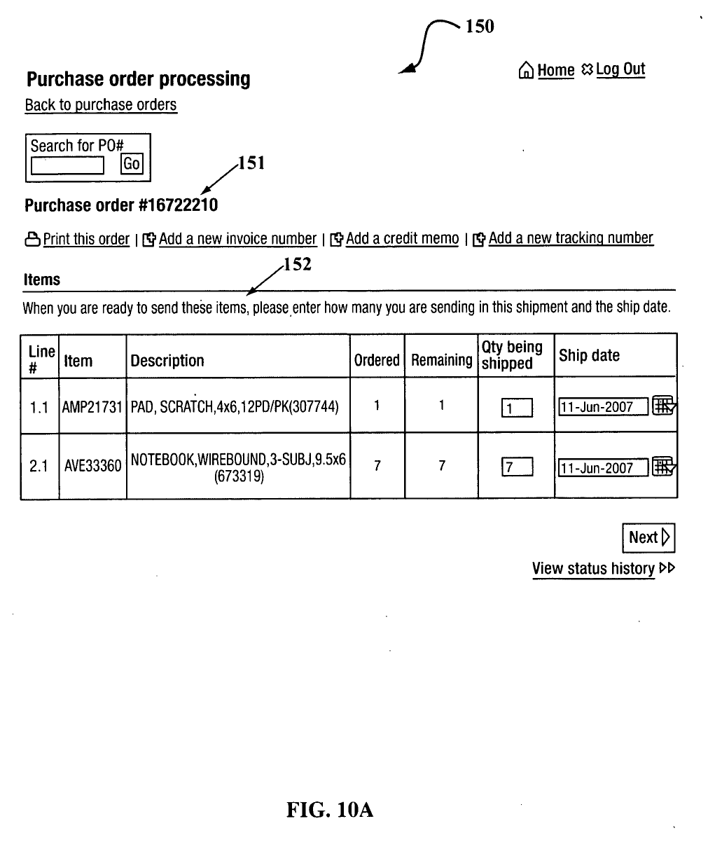

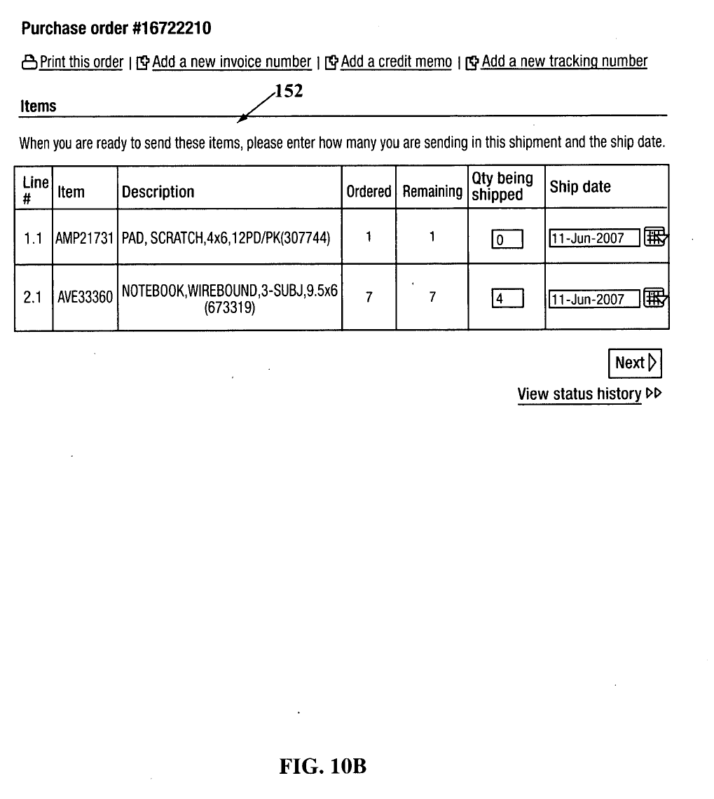

FIG. 10A shows a Purchasing order processing page 150 for processing purchase orders. Preferably, only administrators or users with the invoicing role can add a new invoice; however, all users can view invoices. The main purpose of the Purchase order processing page 150 is to allow the user to declare a status for each line item on a normal purchase order, i.e., one that is going to be shipped right away. The Purchase order processing page 150 displays the purchase order number 151 and includes an items listing 152 that shows the lines that are still open or waiting a status, as well as any lines that have already been fully shipped or canceled (fulfilled lines, these line will a 0 in the remaining column).

To begin processing a purchase order, the user navigates to the Main page 100 (FIG. 2) and searches for the desired purchase order (see FIGS. 6A-6H), and clicks on the desired PO number link (see FIGS. 2, 9A-9B) to display the Purchase order processing page 150. The system defaults the Qty Shipped to the Remaining Qty and the Ship Date to the current date. The user can either ship open lines of the purchase order in full with the given Qty and ship date or enter a shipping amount and/or ship dates (see FIG. 10B).

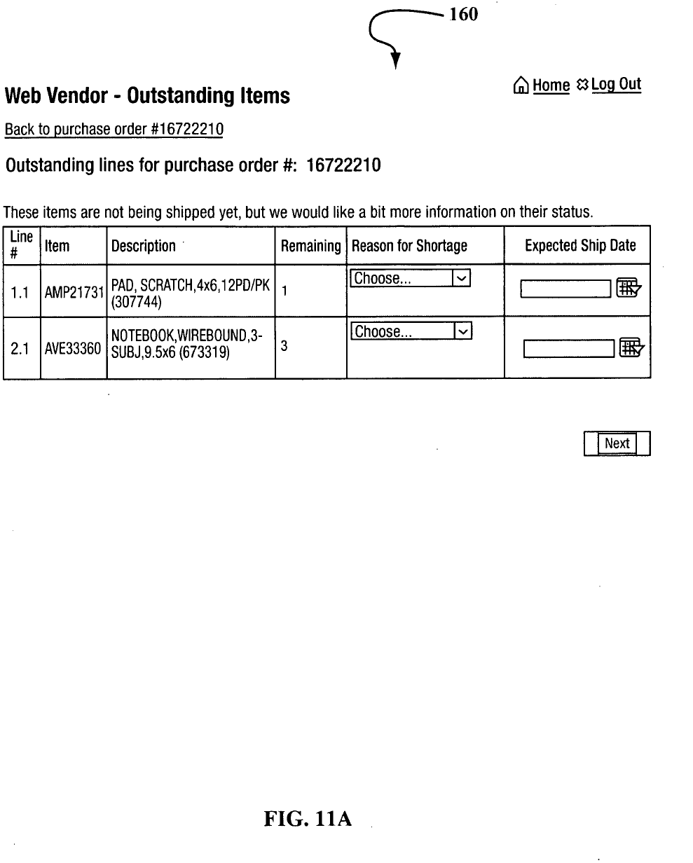

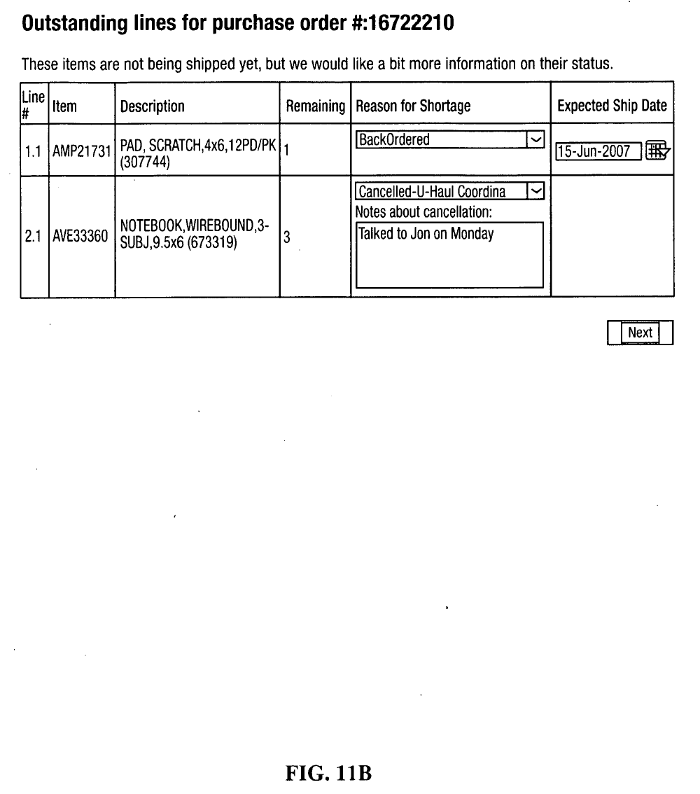

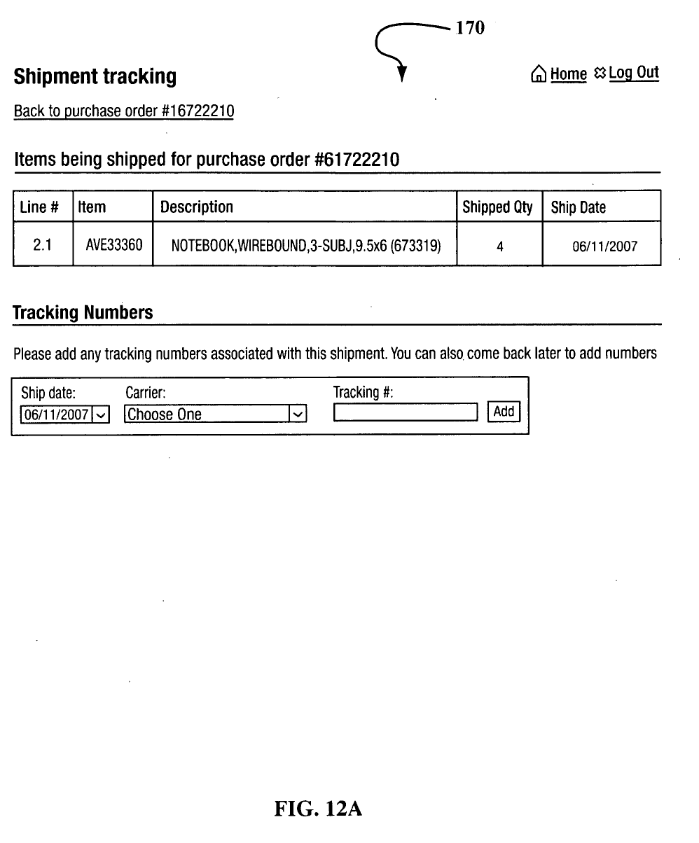

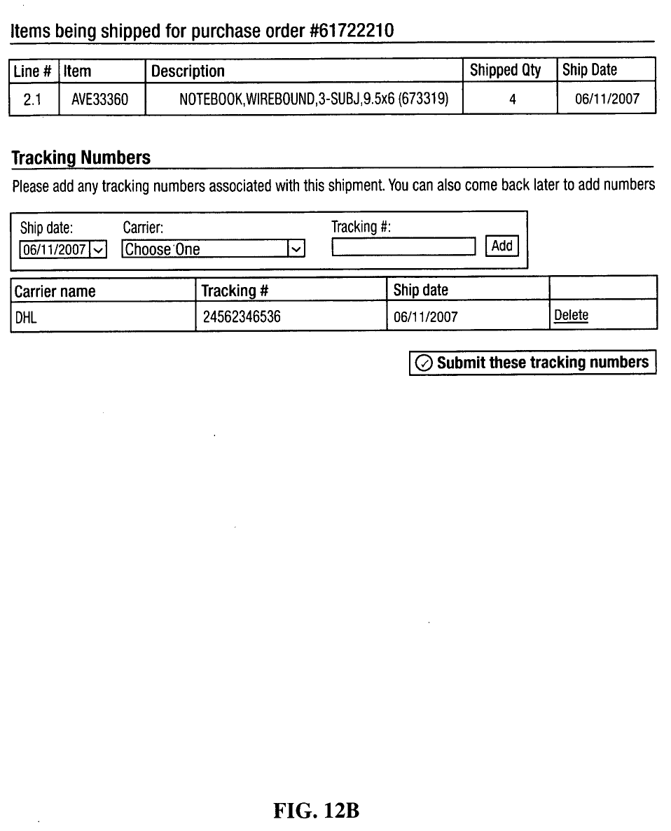

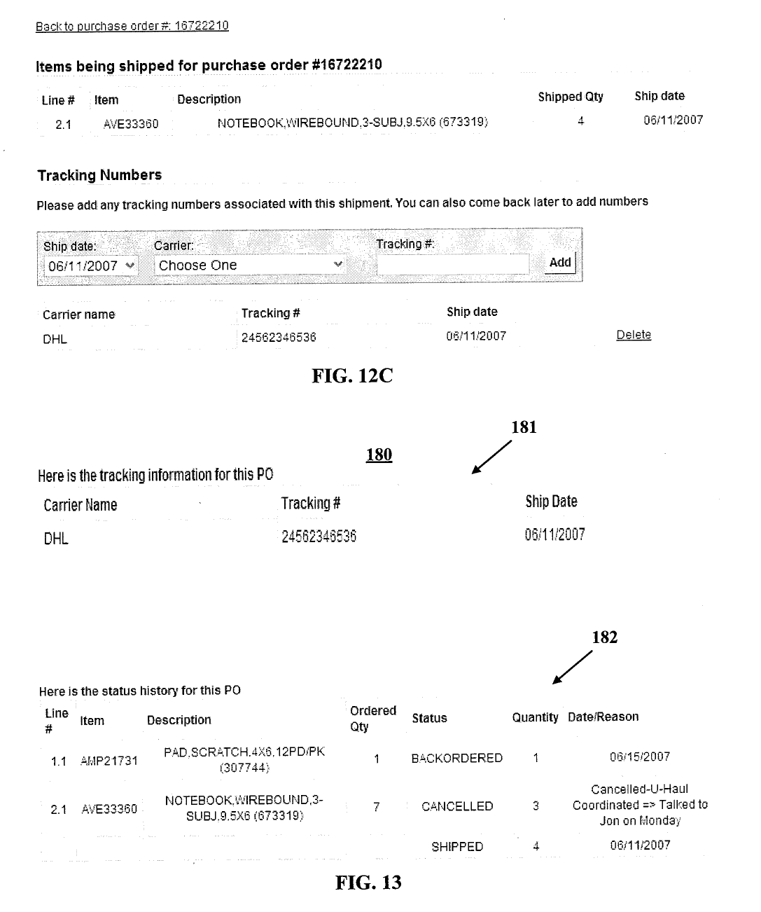

The purchase order processing page 150 also allows the user to print (see FIG. 7), view/add any Invoices, view/add Tracking Information associated with this purchase order (if any) and view the Status History of the purchase order. After the user has entered the Qty Being Shipped for each line, or taken the default, he can enter a ship date if different then the default and click the Next button. If all items have been fully shipped at this time, the system will display a Shipment Tracking page 170 (see FIG. 12). If there are items that need to be Backordered or Canceled, the system will display an Outstanding Items page 160 (see FIG. 11).

Referring to FIGS. 11A-B, the Outstanding Items page 160 displays the purchase order number and the outstanding items that are left to status. A Reason for Shortage drop down box can be used to select a reason for any shortage for each line, and an Expected Ship Date field is used to provide the expected ship date for any backordered items. As shown in FIG. 11B, if the user selects Canceled-Purchaser Coordinated as the reason for a shortage, the system allows the user to enter optional information, such as who the user spoke to and the date.

Referring to FIGS. 12A-C, the purpose of Shipment Tracking page 170 is to assign a carrier and associated tracking number to each ship date from the previous page. The ship dates that the user selects from the Initial Processing page will populate in the Ship Dates drop down list. If there is only one date to display, then it will default to that date; if not, the user chooses the ship date and then adds the carrier and tracking information. If the user selects “Local Delivery” (which means that the vendor delivered the part to the requesting location) or “Will Call” (which means the requesting location will pick up the part from the vendor), the tracking number will default to N/A. If the user selects “Other,” the system will prompt the user to enter a carrier that is not in the list provided. Once these fields are completed, the user clicks on the Add button to add this tracking information, which is shown in FIG. 12B.

The user repeats these steps for as many tracking numbers as the user has. The user can enter multiple tracking numbers for each ship date, if needed. If the user entered the tracking information incorrectly, the tracking line can be deleted by clicking on the Delete link associated with that line. When complete, press the submit button.

Tracking information also can be added from the main purchase order processing page 150 (see FIG. 10A). To do this, the user clicks on the Add Tracking Number link and the system displays the Shipment Tracking page 170 and shows all of the shipping that has occurred for this purchase order, and all of the tracking information.

As shown in FIG. 12C, the Shipment Tracking page 170 allows the user to add or delete tracking information if they have made a mistake or have forgotten to add something. To do so, the user selects a ship date, chooses a carrier and enters a tracking number. The use than clicks the Add button to add the information. When finished, the user clicks the “Back to purchase order” link to return to the Purchase Order Processing page 150.

Viewing Status History

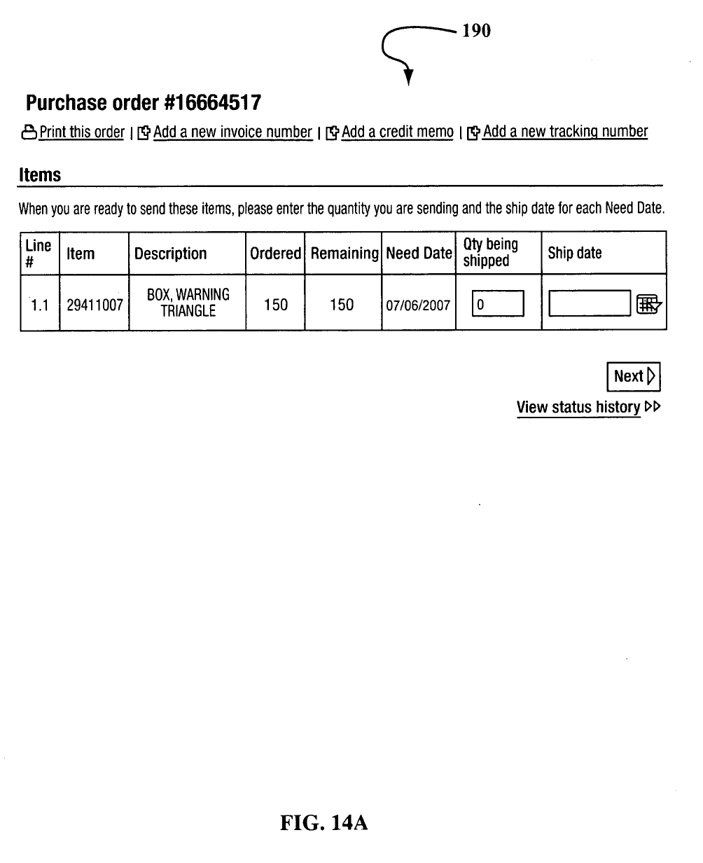

FIG. 13 shows a View Status History page 180 for viewing the status history of a purchase order. To view such a status history, a user searches for a purchase order and clicks on the View Status History link at the bottom of the Purchase order processing page (see FIGS. 10A-B). As shown in FIG. 13, the system then displays the view status history page 180, which includes tracking information 181 associated with this purchase order and a status history grid 182 that breaks down each line on the PO and details exactly what was done to it. The status history grid 182 shows the line information (item and description), how many items were ordered, what was done (shipped, backordered, canceled), how many items were shipped, backordered or canceled, and what the ship date, expected ship date or cancellation reason was.

Release PO Processing

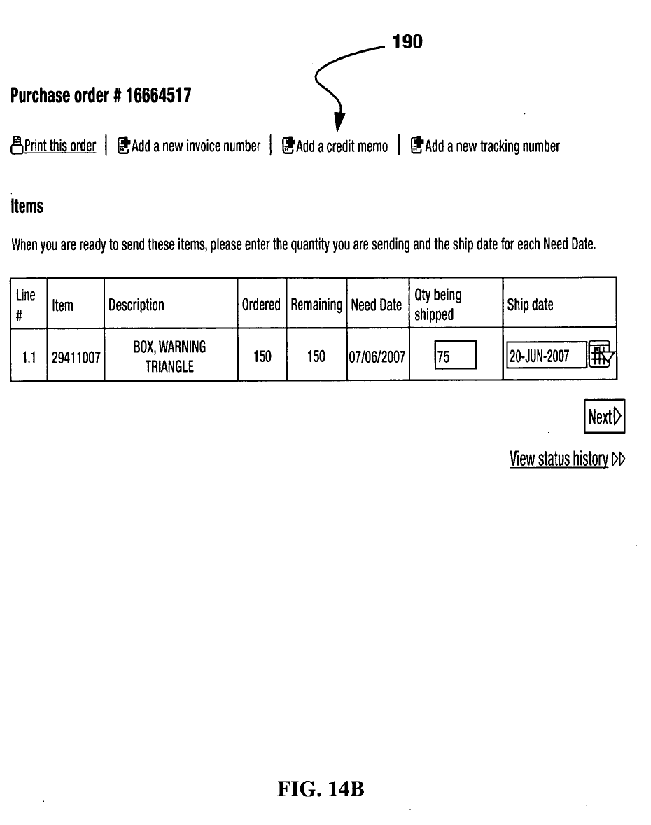

FIG. 14A shows a Release Purchase Order Processing page 190. The main purpose of this page is to assign information for each line item on the purchase order by release date. A release purchase is one that is not going to be shipped right away, but has Release Dates scheduled for shipment. These dates are the dates by which the purchaser needs the item. It shows the lines that are still open or that have not reached the release date yet, as well as any lines that have already been fully shipped or canceled (Fulfilled lines, these lines will have a 0 in the remaining column).

To begin processing a purchase order, the user searches for the purchase order and clicks the PO link. The system loads the PO Processing page for the Release PO (FIG. 14A). It is similar to the PO Processing page 150 for the Normal purchase orders (see FIG. 10A). The user assigns a shipping quantity and a ship date for each need date (FIG. 14B). The Release Purchase Order Processing page 190 also allows the user to Print the PO (see FIG. 7), view/add any Invoice (as discussed above), view/add Tracking Information associated with this PO (if any) and view the Status History of the PO.

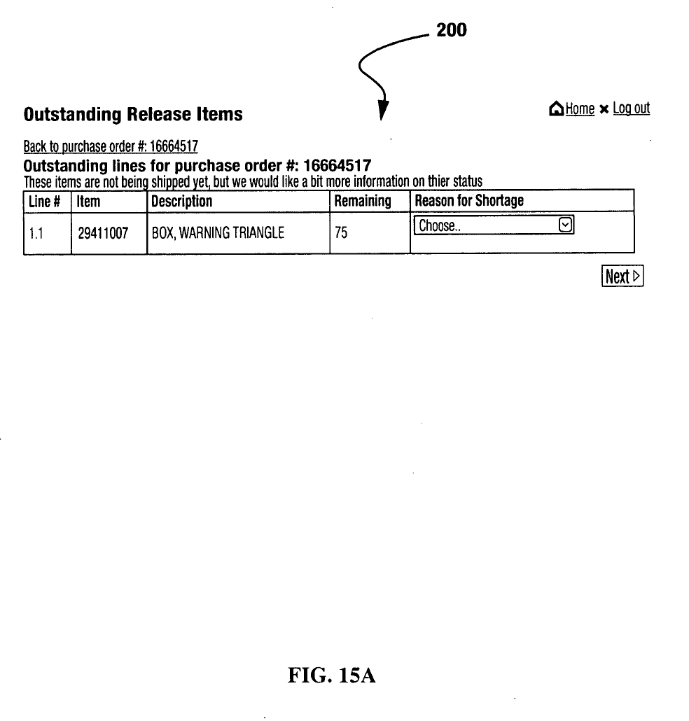

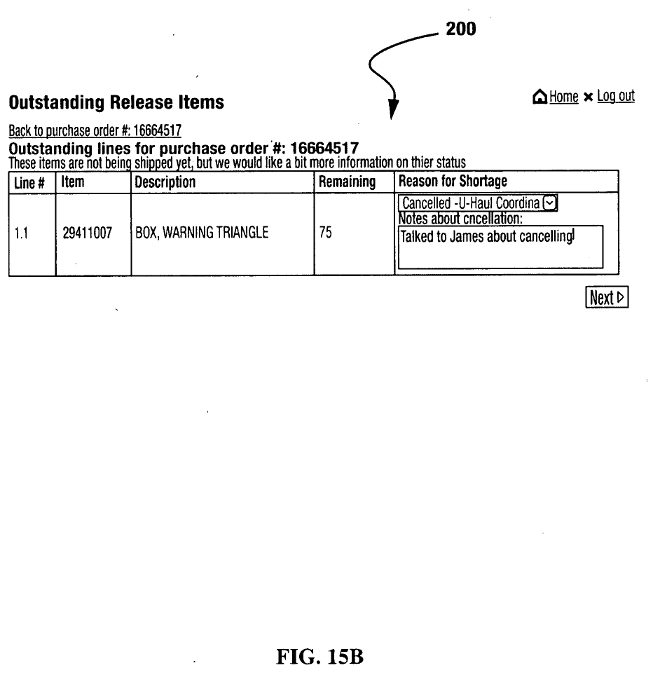

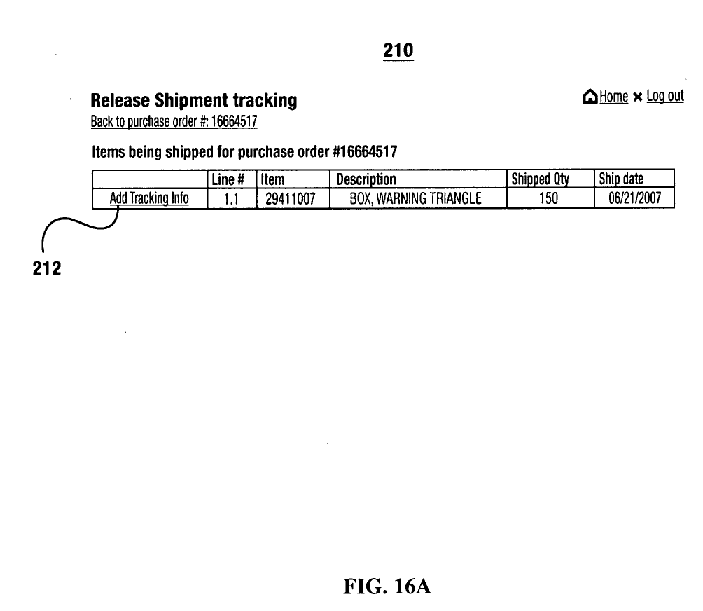

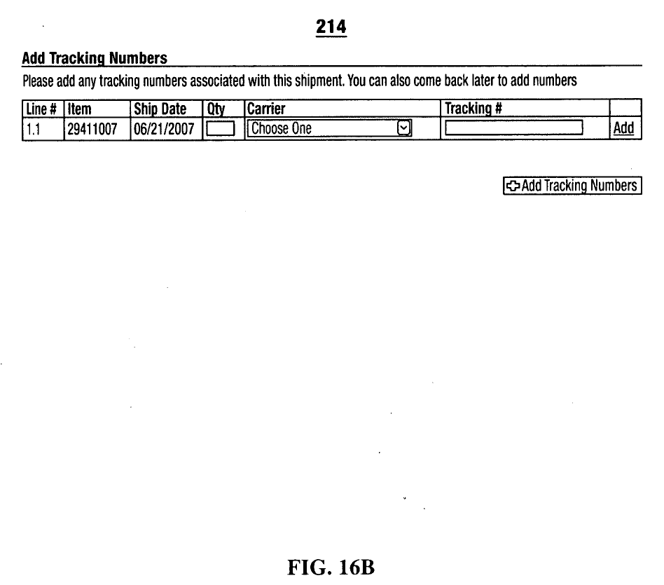

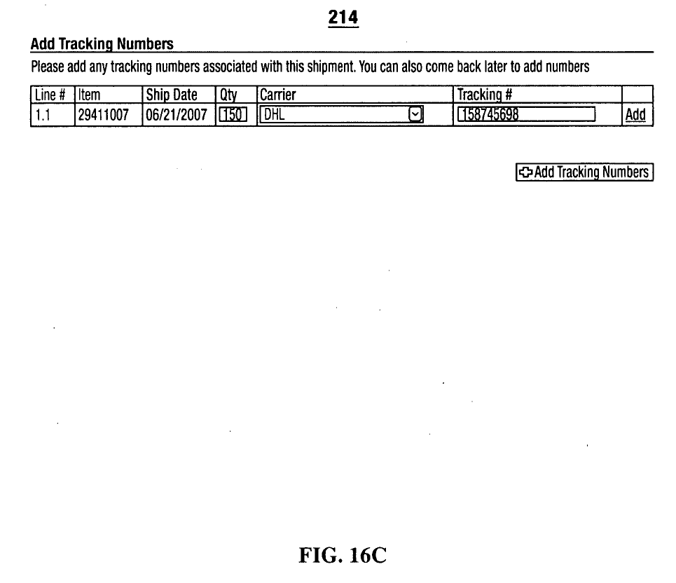

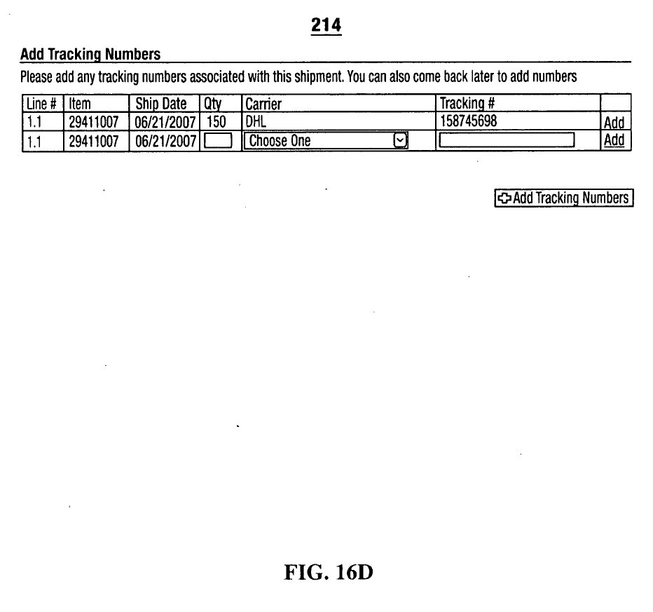

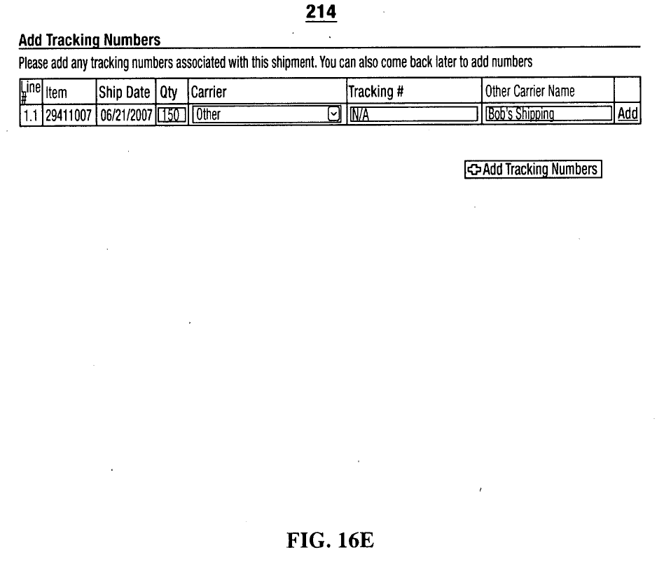

After the user has entered the Qty Being Shipped for each need date, the user clicks the Next button. If an entire release line was not shipped, the system will display the Outstanding Release Items page (FIG. 15A) where the user can cancel the remaining quantity if needed or advise the purchaser that the remaining quantity will be shipping a later date. If the entire release item is shipped, the system will display the Release Shipment Tracking page (FIG. 16A). This page displays only those items that were shipped but not shipped in full. A Drop down box is used to enter a reason for the shortage. The system will also allow the user to enter a note if they select Canceled-Purchaser Coordinated (FIG. 15B).

Once the user has completed all items either by putting a cancellation reason or advising the purchaser that the remainder of the items will be shipping at a later date, the user clicks the Next button to begin entering Tracking information on the lines that have shipped.

Adding Tracking Information

FIG. 16A shows a Release Shipment tracking page 210. The purpose of this page is to assign a carrier and associated tracking number to each need date from the previous pages. All of the lines that the vendor shipped from the processing page will be populated in the grid on the Release Shipment tracking page 210. To add a tracking number to this line, the user clicks on the Add Tracking Info link 212 and the system displays an Add Tracking Numbers page 214 to allow the user to add one or more tracking lines by entering a quantity, the carrier and the tracking number for this line, as shown in FIGS. 16B-C. If the user wishes to add another line, they can click the Add link at the end of the line, and again, enter the quantity, carrier and tracking number, as shown in FIG. 16D. If the user selects “Other” from the Carrier drop down list, a new column will show up to allow the user to enter in another carrier than what is in the list (see FIG. 16E).

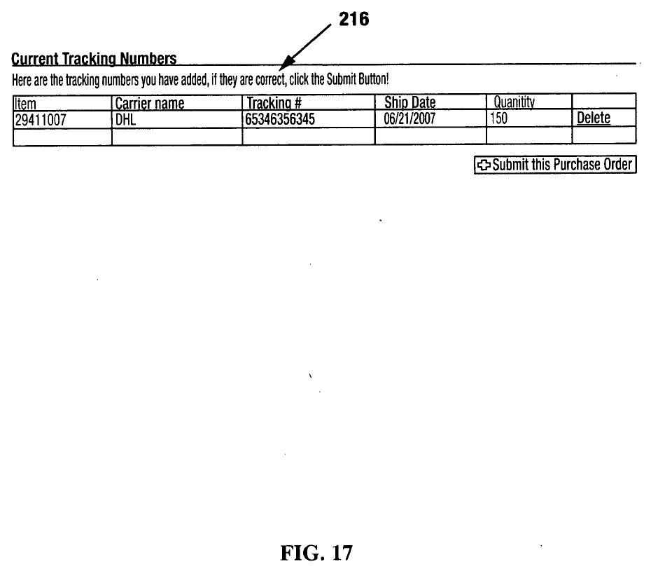

The user can repeat these steps as many times as needed to enter all tracking information for a line. When the user has finished entering tracking information for the line, they click the Add Tracking Numbers button and the system will display all of the tracking information 216 that has been added (see FIG. 17). If a mistake has been made when entering the tracking information, the user can delete that line by clicking on the Delete link. The user repeats these steps for each line that has been shipped. When all tracking information has been completed, the user clicks the Submit this Purchase Order button to complete the process. The user can enter multiple tracking numbers for each ship date if needed.

The user can also add tracking information from the main processing page (see FIG. 10A). To do this, the user clicks on the Add Tracking Number link and the system will display the Tracking page and will show all of the shipping that has occurred for the subject purchase order to this point along with all of the tracking information.

Viewing Status History

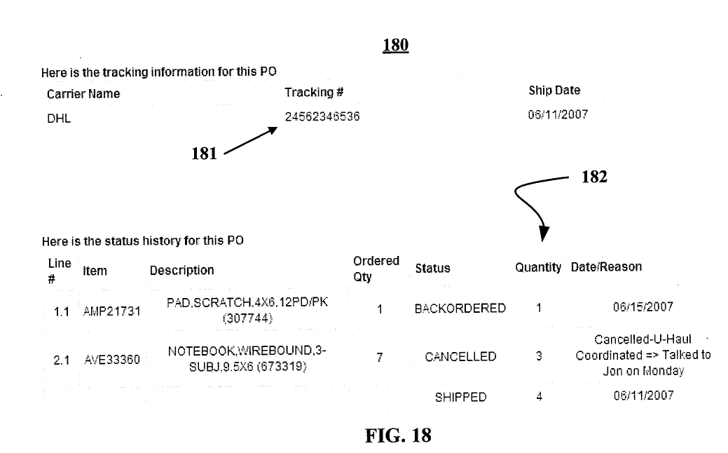

To view the status history of a purchase order, the user searches for the purchase order and clicks on the View Status History link at the bottom of the Purchase Order Processing page 150 (see FIG. 10A). As shown in FIG. 18, the system then displays the view status history page 180, which includes the tracking information 181 associated with this purchase order and a status history grid 182 that breaks down each line on the PO and details exactly what was done to it. This shows the line information (item and description), how many items were ordered, what was done (shipped, backordered, canceled), how many items were shipped, backordered or canceled, and the ship date, expected ship date or cancellation reason.

Invoicing

This section describes the invoicing process. Preferably, only Administrators or those users with the Invoicing Role can add a new Invoice. Also, if all lines of a purchase have been fully invoices or if no lines of the purchase have shipped, an invoice cannot be added.

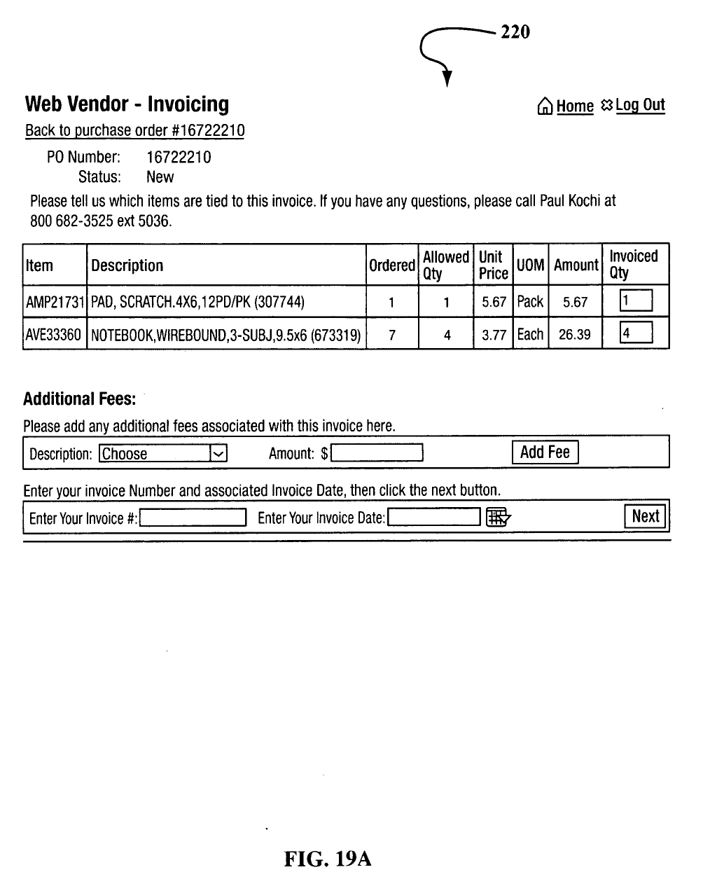

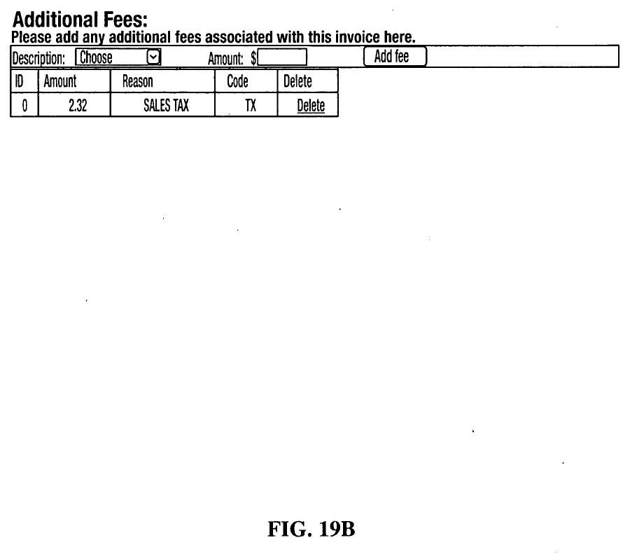

To add a new invoice, the user search for the purchase order as described above and clicks on the Add Invoice link on the Purchase Order Processing page 150 (see FIG. 10A). The system then displays an Invoicing page 220 as shown in FIG. 19A. This page shows all of the lines associated with the purchase that have yet to be fully invoiced, along with the Allowable Qty that can be invoiced which is defaulted to the Allowed Qty. The user can either keep the default or enter a new Qty in the text boxes provided.

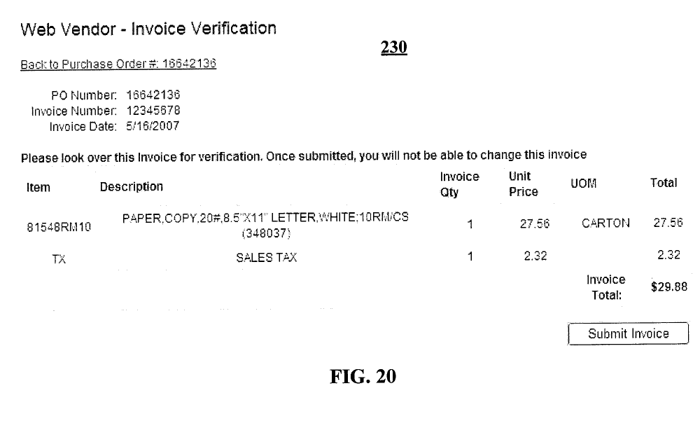

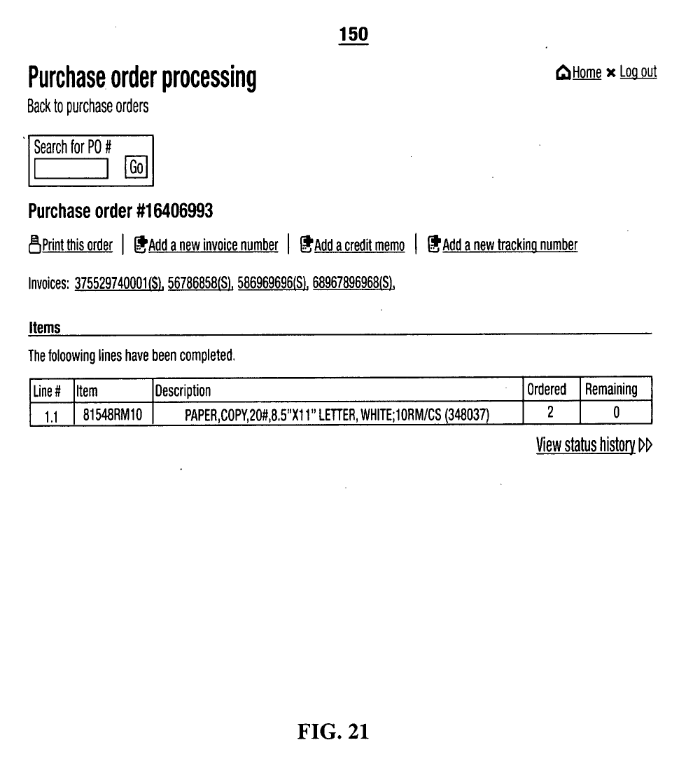

An Additional Fees section covers any additional fees that need to be associated with the Invoice such as Sales Tax, Freight, etc. (see FIG. 19B). With the drop down list, the user can select an additional fee along with an amount, and then click the Add button. When finished adding fees, the user enter an Invoice Number and the date from you invoice, then clicks the Next button. The system will then display an Invoice Verification page 230 as shown in FIG. 20. This page allows the user to verify the invoice just entered to make sure that it is correct. The user then clicks on the Submit Invoice button to finalize and upload the invoice to the purchaser. The system will then display the Purchase Order Processing page 150, as shown in FIG. 21.

Viewing Invoices

To view an invoice, the user searches for the purchase order that is associated with the invoice. Referring to FIG. 21, the Purchase Order Processing page 150 lists Invoice numbers that have already been created, along with a designation indicating the status of the invoice as follows:
1. (S)→ Submitted—Means Invoice has been submitted and has been placed in queue to go to Accounts Payable.
2. (A)→ Accepted—Means that Accounts Payable has accepted this Invoice, but has not paid it.
3. ($)→ Paid—Accounts Payable has sent a check for this invoice.

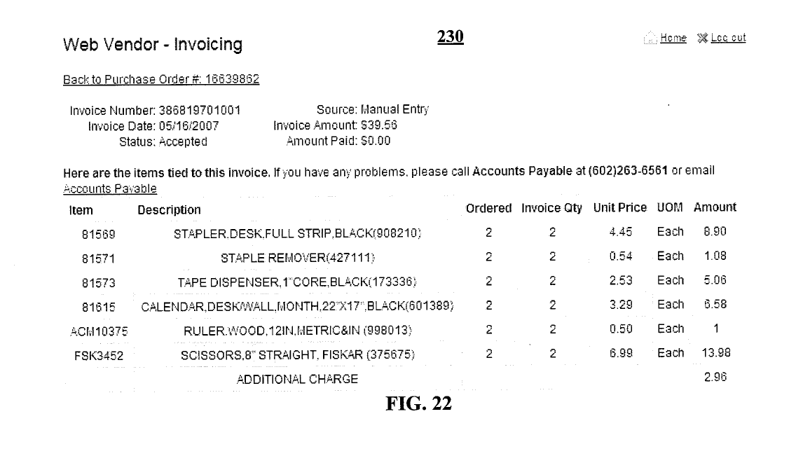

To view an invoice, the user clicks on the link associated with the invoice number. The system then displays an Invoicing page 240 showing a submitted invoice, as shown in FIG. 22. If this invoice was paid, this page will also show the check amount, the check date and the check cleared date.

Creating a Credit Memo

This section describes the process of creating a Credit Memo. This used if a vendor need to credit funds back to the purchaser. Preferably, only Administrators or those users with the Invoicing Role can create a Credit Memo. If there are no invoices submitted, no credit memo can be created.

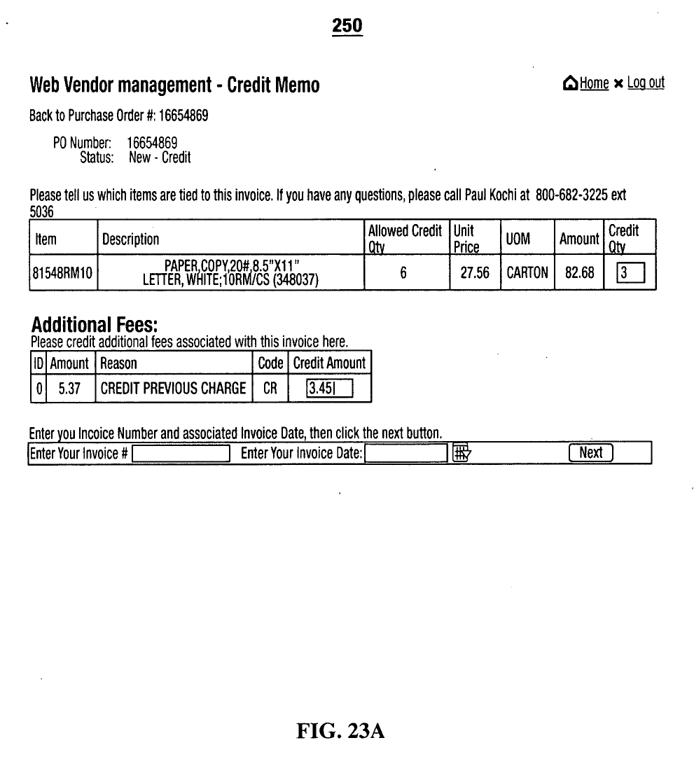

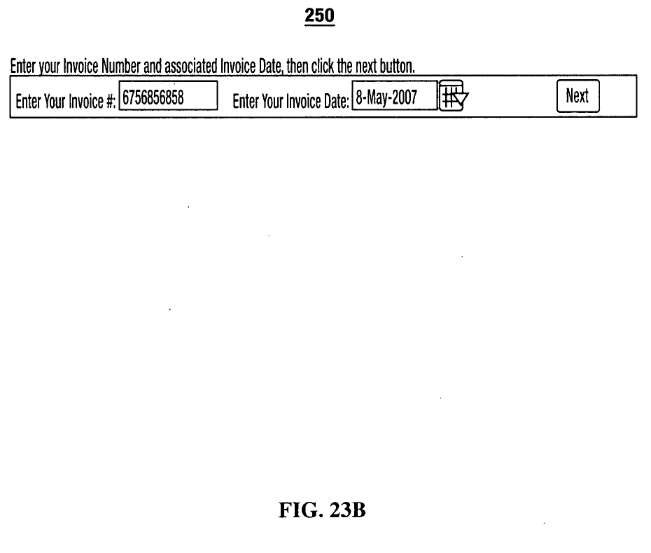

To create a credit memo, the user navigates to the purchase they would like to credit by using the Search for PO# field (See, e.g., FIGS. 10A and 21). The user clicks on the Add Credit Memo link, and the system then displays a Credit Memo page 250 as shown in FIG. 23A. The Credit Memo page 250 shows the total number of items that have been invoiced for the purchase order, along with the additional fees if any. The user enters an amount in the text box for the number of items that the user would like to credit back to the purchaser.

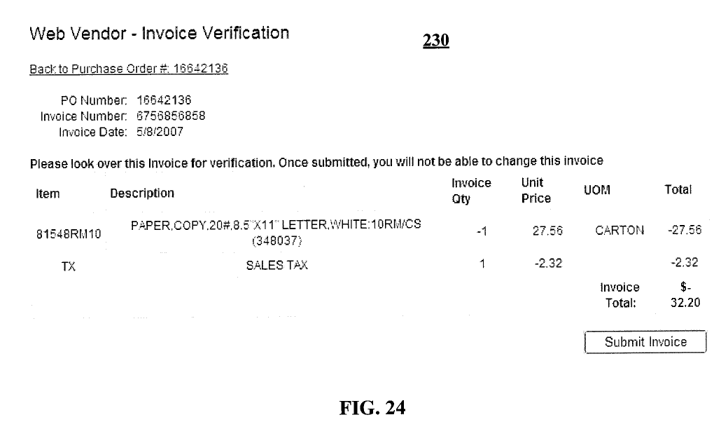

The next step is to credit any tax, shipping or any other additional fee. The Credit Memo page 250 shows all of the additional charges that were applied to all of the invoices associated with the purchase order. The user enters the amount to be credited up to the total amount shown the Amount column. The user then enters invoice number and the invoice date and then clicks the Next button (see FIG. 23B). The system then displays an Invoice Verification page 230 showing the invoice to be credited, as shown in FIG. 24. After verifying, the system returns the user to the Purchase Order Processing page 150.

Upon reading this disclosure, those skilled in the art will appreciate that various changes and modifications may be made to the preferred embodiments of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for managing vendor information using a website, the method including:
storing at the website information associated with one or more purchase orders of a purchaser, including information associating the purchase order with a vendor authorized to access the website; and
using the website to:
allow the vendor to retrieve the purchase order;
automatically notify the purchaser of the vendor's receipt of the purchase order;
allow the vendor to create an invoice associated with the purchase order; and
automatically enter the invoice into an accounts payable system of the purchaser.

2. The method of claim 1 further comprising using the website to allow the vendor to assign the purchase order a status.

3. The method of claim 2 further comprising using the website to automatically notify the purchaser of the vendor's assignment of a status to the purchase order

4. The method of claim 1 further comprising using the website to allow the vendor to associating shipment tracking information with a purchase order.

5. The method of claim 1 further comprising using the website to allow the vendor to view the status history of a purchase order.

6. The method of claim 1 wherein the purchase order information includes release date information associated with a purchase order.

7. The method of claim 1 further comprising using the website to allow the vendor to view the invoice and status information associated with the invoice.

8. The method of claim 7 wherein the status information associated with the invoice includes information indicating whether the invoice has been submitted.

9. The method of claim 7 wherein the status information associated with the invoice includes information indicating whether the invoice has been accepted.

10. The method of claim 7 wherein the status information associated with the invoice includes information indicating whether the invoice has been paid.

11. The method of claim 1 further comprising using the website to allow the vendor to create a credit memo associated with the invoice.

12. The method of claim 1 further comprising storing information associated with the vendor and the vendor's performance.

13. The method of claim 12 wherein the information associated with the vendor's performance includes information relating to purchase orders that have not been acknowledged by the vendor.

14. The method of claim 12 wherein the information associated with the vendor's performance includes information relating to purchase orders that have not been assigned a status within a specified time.

15. The method of claim 12 wherein the information associated with the vendor's performance includes information relating to purchase orders that include backordered items.

16. The method of claim 12 wherein the information associated with the vendor's performance includes information relating to timeliness of the vendor's shipment.

17. The method of claim 12 further comprising using the website to allow the purchaser to view the information regarding the vendor's performance.

18. The method of claim 1 further comprising using the website to store agreements associated with the vendor.
